(19) United States
(12) Patent Application Publication
(10) Pub. No.: US 2011/0095894 A1
(43) Pub. Date: Apr. 28, 2011

(54) PORTABLE FISH BITE ALARM DETECTOR AND FISHING LINE RELEASE APPARATUS

(76) Inventors: AMY GIBSON, Sumter, SC (US); Mark Gibson, Sumter, SC (US)

(21) Appl. No.: 12/846,737

(22) Filed: Jul. 29, 2010

Related U.S. Application Data
(60) Provisional application No. 61/254,682, filed on Oct. 24, 2009.

(51) Int. Cl. G08B 23/00

(52) U.S. Cl. 340/573.2

(57) ABSTRACT

A fish bite alarm detector and fishing line release apparatus for a fishing pole which comprises a clothespin having a spring between two operable levers. A mechanism is for removably securing the first lever of the clothespin to the fishing pole, whereby the fishing line of the fishing pole can be gripped by claw ends of the two levers of the clothespin. A buzzer mechanism is on the clothespin for audibly indicating and a LED for visually indicating that a fish is nibbling bait on a hook of the fishing line, when the fishing line is pulled by the fish and released from between the claw ends of the two levers of the clothespin.

### CROSS-REFERENCE TO RELATED APPLICATION

This application claims the benefit of Provisional Patent Application No. 61/254,682, filed on Oct. 24, 2009, In the United States Patent & Trademark Office, the disclosure of which is incorporated herein by reference.

### BACKGROUND OF THE INVENTION

1. Field of the Invention

The present invention relates to a signal device, and more particularly, a fish bite alarm detector. The fish bite alarm detector can be used by anglers to increase the likelihood of catching a fish. After a fish bites the bait, the present invention will automatically release a fishing line from a fishing pole preventing the fish from feeling the tension of the fishing line. This will greatly increase the odds of catching a fish by making the angular feel happy and successful. The fish bite alarm detector comes equipped with a buzzer and a light emitting diode (LED) that will indicate to the angler when a fish is biting. It can be attached to any fishing pole without the use of tools making it easy to use and beneficial to all anglers of any age.

2. Description of the Prior Art

Fishing is a sport that manages to be both relaxing and frustrating at the same time. Catching a fish requires an angler to know many different nuisances of the water, the fish species, and the equipment they are using. It is common for a fish to nibble on the bait on the end of a hook only to dart away because they feel the tension of the attached fishing line. Many anglers know they would be able to catch more fish if they were able to leave their reel in an unlocked position because the bait would feel more natural to the fish this way.

Numerous innovations for fishing indicator devices have been provided in the prior art that will be described. Even though these innovations may be suitable for the specific individual purposes to which they address, however, they differ from the present invention.

A FIRST EXAMPLE, U.S. Pat. No. 2,549,694, Issued on Apr. 17, 1951, to Leyda teaches in a conductive fishing rod handle, a switch comprising a conductive support mounted on the handle, a contact carried by the support, a coil spring secured at one end to the support and having a free end disposed adjacent the contact and responsive to a pressure on a fishing line for engaging the contact, and means threaded to the support and extending axially through the coil spring for limiting the flexing movement of the spring whereby a predetermined pull on a fishing line is required for flexing the spring into engagement with the contact.

A SECOND EXAMPLE, U.S. Pat. No. 4,384,425, Issued on May 24, 1983, to Lemons Sr. teaches a signal device associated with a fishing rod and fishing line mounted thereon to automatically indicate to a fisherman that a fish has taken the bait by providing both a visual signal and audible signal. The fishing rod bite signal includes a light and buzzer connected to a battery or batteries through a switch mechanism having an actuator engaged with the fishing line. The switch actuator includes a resilient body having a longitudinal recess therein for frictional engagement with the fishing line so that the fishing line can be engaged with the switch actuator at any point along its length and the switch actuator will release the line when the fishing line reel is actuated to reel in the line and also release the line in the event of outward tension being exerted on the line beyond a predetermined tension so that the fish which has taken the bait can, in some instances, pull the line outwardly and unreel it from the fishing reel. The signal device includes an adjustment feature to enable the sensitivity thereof to be varied so that the signal device can be adapted for use under various fishing conditions and to compensate for drag on the fishing line which may occur when fishing in rather swift water or trolling.

A THIRD EXAMPLE, U.S. Pat. No. 4,458,437, Issued on Jul. 10, 1984, to Ou teaches a signal device for use in fishing that includes an adjustable contact member and a slidable contact member which can be moved into contact with each other by a fish when striking the bait to cause energization of a relay means for controlling the operation of a buzzer and lamp system. A normally closed reset switch is provided for maintaining the energization of the relay means in case the two contact members are out of contact with each other so that signals from the buzzer and lamp system are continuously produced to positively warn of a hooked fish.

A FOURTH EXAMPLE, U.S. Pat. No. 4,586,284, Issued on May 6, 1986, to Westwood III teaches a fishing line signaling device for attachment to a fishing rod and receiving the fishing line in a manner that a visual or audible alarm or both will be activated when the fish strikes or takes the bait thereby alerting the person using the fishing rod to the fact that a fish has taken the bait or hook. The fishing line signal is battery operated, provided with a switch to selectively actuate either or both the visual and audible signals and is adaptable to any size fishing rod, used with any type of reel and allows a person to fish with more than one rod at a time and is suitable for trolling, still water fishing, night fishing, ice fishing and fresh or salt water fishing. The signaling device includes a switch arm that frictionally grips the fishing line and is spring biased with an adjustment device varying the sensitivity of the device so that when the fishing line is pulled, it is removed from the signaling device so that the switch arm can move to close an electrical circuit to operate a buzzer or light or both.

A FIFTH EXAMPLE, U.S. Pat. No. 5,261,180, Issued on Nov. 16, 1993, to Foster et al. teaches an improved fishing rod/line signaling device for attachment to a rod near the handle/reel thereof, the signaling device receiving the fishing line in such manner that an alarm, visual and/or audible will be activated when a fish strikes or takes the bait; the alarm device including a battery power source, a pair of spring biased elements adapted to receive the fishing line therewithin and permit the fishing line to be pulled out therefrom, a switch to activate or deactivate the entire circuit and a sound making device such as buzzer and a light making device such as an LED (light emitting diode) all making up the mechanism or system.

A SIXTH EXAMPLE, U.S. Pat. No. 5,321,903, Issued on Jun. 21, 1994, to Ebener teaches a compact signaling device mounted on a fishing pole for visually alerting a fisherman when a fish strikes the fishing line. The device comprises an electrical circuit including an LED, a battery, a switch for opening and closing the electrical circuit and a normally-closed pivoting arm that mechanically opens the switch when a portion of fishline is placed under the pivoting arm. When tension on the fishline increases sufficiently to remove it from under the pivoting arm, such as when a fish strikes the fishing line, the pivoting arm moves to close the switch thus illuminating the LED and alerting the fisherman. Also, the device has a rack and pinion gear or, alternatively, a threaded thumb screw for adjusting the pivoting arm so that the tension required to remove fishline from the pivoting arm can be varied in preselected increments.

A SEVENTH EXAMPLE, U.S. Pat. No. 5,682,703, Issued on Nov. 4, 1997, to Corbiere teaches a fishing rod alarm apparatus to provide the user indications of pressure on the line caused by the bite of a fish. The apparatus has a molded housing that contains an alarm system and a power source. The alarm is attached to a primary pin. A metal rod controlled by a magnet is held away from the primary pin when no pressure is maintained on the fishing rod. The metal rod is in normal contact with a secondary pin via a second magnet, and the secondary pin is attached to the power source. When pressure on the fishing line causes the metal rod to come into contact with the primary pin, the circuit is completed and the alarm will sound. As the pressure is increased the metal rod will be pulled away from the secondary pin and magnet which will result in the alarm being silenced. The magnet is positioned on a moveable slide to allow for changes in wind or water conditions such as current. When pressure is released from the line the magnets will return the metal rod to its original position.

AN EIGHTH EXAMPLE, U.S. Pat. No. 5,771,624, Issued on Jun. 30, 1998, to Vickery et al. teaches a fish bite alert device which includes a 3-position adjustable gripper that provides a positive line gripping action in a set mode yet completely releases the line, entirely free of the fish bite alert device, in a release position. The gripper is illuminated for night fishing. The fish bite alert device also includes a 3-mode selector switch to choose light-only operation, light and buzzer operation, and an off position. The light assists the hearing impaired, while the buzzer is beneficial to the sight impaired.

A NINTH EXAMPLE, U.S. Pat. No. 6,568,121, Issued on May 27, 2003, to Gonzales teaches a fish bite indicating apparatus for alerting a user of a fish bite. The fish bite indicating apparatus includes a housing having an exterior with a top side, a bottom side, a first end, and a second end. An indicator is provided for indicating movement of a fishing line in a manner corresponding to biting on a lure on an end of the fishing line. The indicator emits a signal when actuated. A mounting structure is provided for mounting the housing on the fishing pole. An actuating mechanism is provided for actuating the indicator upon detection of movement of the fishing line in a manner corresponding to biting on a lure on an end of the fishing line.

A TENTH EXAMPLE, U.S. Patent Office Publication No. 2003/0097779, Published on May 29, 2003, to Shakelford teaches an improved fish bite alarm and fishing line release device that provides immediate release of a fishing line and activation of a fish bite alarm due to the use of spring biasing. The line holding and release device preferably includes two fingers arranged for holding the fishing line, a spring bias means for triggering the release of the line, an alarm circuit, and a spring bias means for activating the alarm circuit.

AN ELEVENTH EXAMPLE, U.S. Patent Office Publication No. 2005/0011105, Published on Jan. 20, 2005, to Cameron et al. teaches a battery powered fishing line bite detector alarm producing visible and/or audible alarm signals. An arm, installed within the alarm, integrally connects to a modified leaf on-off switch. The alarm attaches to a fishing rod in front of a fishing reel mounted on the rod. Fishing line is threaded into the arm and adjusted such that slack is provided between the rear of the alarm and the front of the reel thereby allowing forward arm movement. The fishing line is further inserted until desired resistance of forward and backward line movement within the arm is achieved. Applied tension to the line forces the arm to actuate. A tension spring clip connected to a switch lever, and a common leaf contact arm, pulls contact arm closer to an upper common contact point until contact is made activating the alarm signals. Increased tensioning pulls the line through a variable sized slit and into a line hole, releasing tension on the arm and causing the contact arm and contact point to break contact, while allowing the arm to return to a self-adjusting alarm casing position.

A TWELFTH EXAMPLE, U.S. Pat. No. 6,938,367, Issued on Sep. 6, 2005, to Cameron et al. teaches a battery powered fishing line bite detector alarm producing visible and/or audible alarm signals. An arm, installed within the alarm, integrally connects to a modified leaf on-off switch. The alarm attaches to a fishing rod in front of a fishing reel mounted on the rod. Fishing line is threaded into the arm and adjusted such that slack is provided between the rear of the alarm and the front of the reel thereby allowing forward arm movement. The fishing line is further inserted until desired resistance of forward and backward line movement within the arm is achieved. Applied tension to the line forces the arm to actuate. A tension spring clip connected to a switch lever, and a common leaf contact arm, pulls contact arm closer to an upper common contact point until contact is made activating the alarm signals. Increased tensioning pulls the line through a variable sized slit and into a line hole, releasing tension on the arm and causing the contact arm and contact point to break contact, while allowing the arm to return to a self-adjusting alarm casing position.

A THIRTEENTH EXAMPLE, U.S. Pat. No. 6,966,140, Issued on Nov. 22, 2005, to Rozkowski teaches an easy to use signaling apparatus which can be used during an entire year for warm and cold weather fishing to signal a fisherman that a fish has nibbled, struck or hooked a bait. The signaling apparatus can be used with a variety of fishing rods of different diameters. The signaling apparatus is mounted in surrounding relationship to a fishing rod and includes an adjustment for triggering an LED and/or a buzzer at higher or lower tensile forces in a fishing line caused by a fish nibbling, striking or hooking a line. The signaling apparatus has a high resistance to corrosion, is sensitive to low levels of a tensile force in a fishing line and does not affect the stability of a rod and reel.

A FOURTEENTH EXAMPLE, U.S. Patent Office Publication No. 2006/0117638, Published on Jun. 8, 2006, to Park teaches an indicator for fishing which includes a detecting device for detecting the physical property of fishing line, an audio indicating device to alert an angler with sound, and a video indicator to alert the angler with light, according to the change of the physical property of the fishing line. The detecting device can detect the moment of a fish's striking a bait by detecting the tension of the fishing line or the temporal change of the tension of the fishing line held by the fishing line holder. The indicator further includes a fishing rod holder, a fishing line holder, and an illuminating device. The audio indicating device includes a sound producing device and signals the fish's striking by producing a predetermined sound. The video indicating device includes a first lighting device producing a light of a predetermined color, and a second lighting device producing a light of other predetermined color.

A FIFTEENTH EXAMPLE, U.S. Patent Office Publication No. 2006/0218843, Published on Oct. 5, 2006, to Sanchez et al. teach a sensing alarm adapted to provide both (or either) visual and audible alarms to the operator upon the occurrence of an event. In one embodiment, the present invention includes a housing adapted to retain and store control electronics, an indicator on housing which is in electronic communication with the control electronics through a switch, a receiving bracket and a reciprocal contact bracket, at least both members being securely attached to a top portion of the housing and both members being in electrical communication with the control electronics so that when compression occurs between the brackets, an alarm event occurs. In another embodiment, the control electronics may further include a microprocessor in electrical communication with the switch, the microprocessor being adapted to transmit information with a remotely located computer.

A SIXTEENTH EXAMPLE, U.S. Patent Office Publication No. 2006/0265931, Published on Nov. 30, 2006, to Mcfadden et al. teach a fish bite or strike alarm which is attachable to multiple types of rod holders. It alerts the angler of a fish striking or tugging on a baited fishing line. An important feature of the present invention is it not attached to the fishing rod, pole or line in any manner. Like no prior art it is attached to rod holders and extends outward in front of the rod holder. It has a unique fishing rod/pole nest which senses fishing rod/pole pressure exerted by the torsional force of the rod caused by a fish bite/strike activity. The nest cradles the fishing rod or pole and transfers torsional movement from the fishing rod or pole and activates a switch by compression force. When the switch is compressed to the actuation point, a standard battery power source signal is sent to any number of alerts devices such as a pizeo sounder, light emitting diodes LED's, wireless remote embodiments containing but not limited to piezo sounders, LED's, vibrators, and voice programmable audio alerts.

A SEVENTEENTH EXAMPLE, U.S. Patent Office Publication No. 2008/0022577, Published on Jan. 31, 2008, to Duggins teaches a fish bite detector for use on flexible fishing rods to detect and notify the angler that a fish is biting at the bait located at the end of his fishing line. The fish bite detector comprises a first component part configured to be removably placed over an end of a fishing pole and line, a second component part configured to be removably anchored to a fixed surface or object, and line means for flexibly connecting the first component part to the second component part. Line storage means affixed to one of the first or second component parts are also provided. The line storage is preferably affixed to the closed end of the cylindrical body of the first component part.

AN EIGHTEENTH EXAMPLE, U.S. Pat. No. 7,454,861, Issued on Nov. 25, 2008, to Keibler teaches a two-way pre-bite tension adjustment and fishing line release and fish bite alarm apparatus including a non-electrically conductive body housing a battery and an electrically energized auditory-visual alarm. A two-way pre-bite fishing line tensioning mechanism utilizing a frictional tensioning screw together with the leverage gained by a thin elongated flat rotatable truncated U-shaped tensioning lever-alarm activation member to control an electrical switch member to release the fishing line and emit an auditory-visual signal upon a fish taking bait attached to the fishing line.

A NINETEENTH EXAMPLE, U.S. Patent Office Publication No. 2009/0031609, Published on Feb. 5, 2009, to Kirby teaches a fish alarm system comprising: an alarm toggle switch in combination with a tension clip; an enclosure; an alarm; and power source; wherein the alarm toggle switch may include an at least two position switch, having an alarm toggle arm disposed through the enclosure attached with the tension clip such that a fishing line may be inserted in the tension clip whereby as the force on the fishing line increases, the tension of the tension clip may allow the alarm toggle arm to move from an off position to an interim or bite position for activating the alarm, from the interim position to a hook set position for hook set and possible second alarm, and then release the fishing line from the tension clip.

It is apparent now that numerous innovations for fishing indicator devices have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a fish bite alarm detector that avoids the disadvantages of the prior art.

ANOTHER OBJECT of the present invention is to provide a fish bite alarm detector that is simple and inexpensive to manufacture.

STILL ANOTHER OBJECT of the present invention is to provide a fish bite alarm detector that is simple to use.

BRIEFLY STATED, STILL YET ANOTHER OBJECT of the present invention is to provide a fish bite alarm and fishing line release apparatus for a fishing pole which comprises a clothespin having a spring between two operable levers. A mechanism is for removably securing the first lever of the clothespin to the fishing pole, whereby the fishing line of the fishing pole can be gripped by claw ends of the two levers of the clothespin. A mechanism is on the clothespin for audibly indicating that a fish is nibbling bait on a hook of the fishing line, when the fishing line is pulled by the fish and released from between the claw ends of the two levers of the clothespin.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view showing the present invention installed on a fishing pole and in use catching a fish;

FIG. 2 is an enlarged perspective view of the dotted area shown in FIG. 1, as indicated by arrow 2;

FIG. 3 is an enlarged perspective view of the present invention per se;

FIG. 4 is a perspective view taken in the direction of arrow 4 in FIG. 2, showing a fishing line guide post on the present invention; and

FIG. 5 is a schematic diagram showing the electrical circuitry of the present invention.

### REFERENCE NUMERALS UTILIZED IN THE DRAWING

110 fish bite alarm and fishing line release apparatus
112 fishing pole
114 clothespin of apparatus 110
116 spring of clothespin 114
118 first lever of clothespin 114
120 second lever of clothespin 114
122 removably securing mechanism of apparatus 110
124 fishing line of fishing pole 112
126 claw end of first lever 118
128 claw end of second lever 120
130 audibly indicating mechanism of apparatus 110
132 fish
134 hook of fishing line 124
136 visually indicating mechanism of apparatus 110
138 flexible sea shaped clip of removably securing mechanism 122
140 housing of audibly indicating mechanism 130
142 battery of audibly indicating mechanism 130
146 normally closed contact switch (optional) of audibly indicating mechanism 130
147A upper metal tongue of claw end 128
147B lower metal tongue of claw end 126
148 buzzer of audibly indicating mechanism 130
150 light emitting diode (LED) of visually indicating mechanism 136
152 handle of second lever 120
154 guide post of apparatus 110

### DETAILED DESCRIPTION OF THE PREFERRED EMBODIMENT

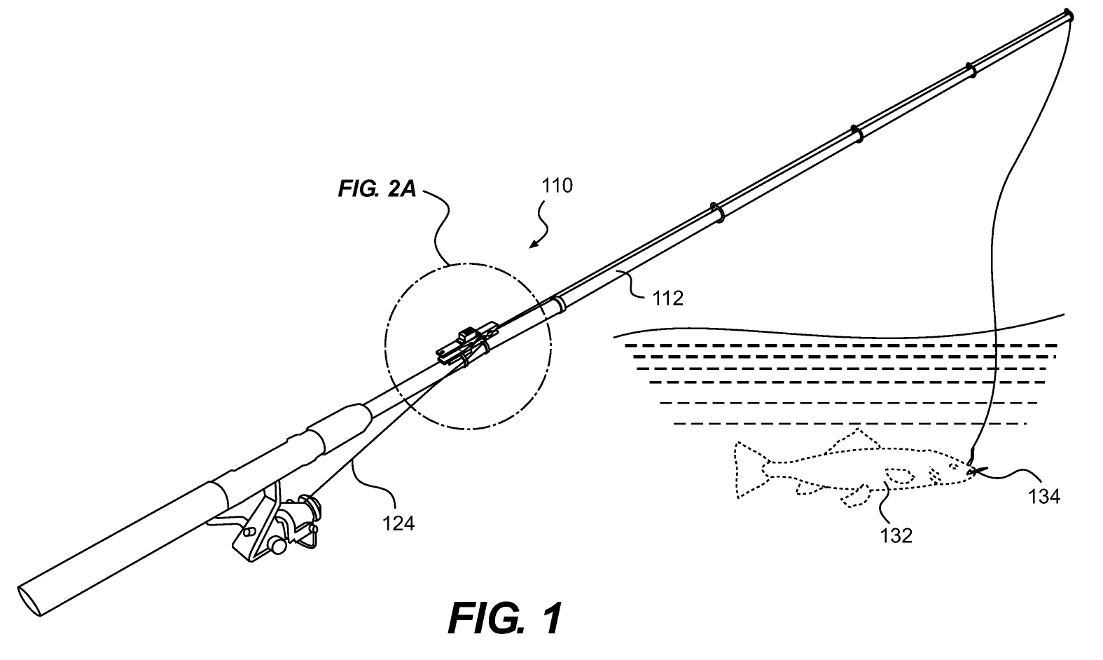

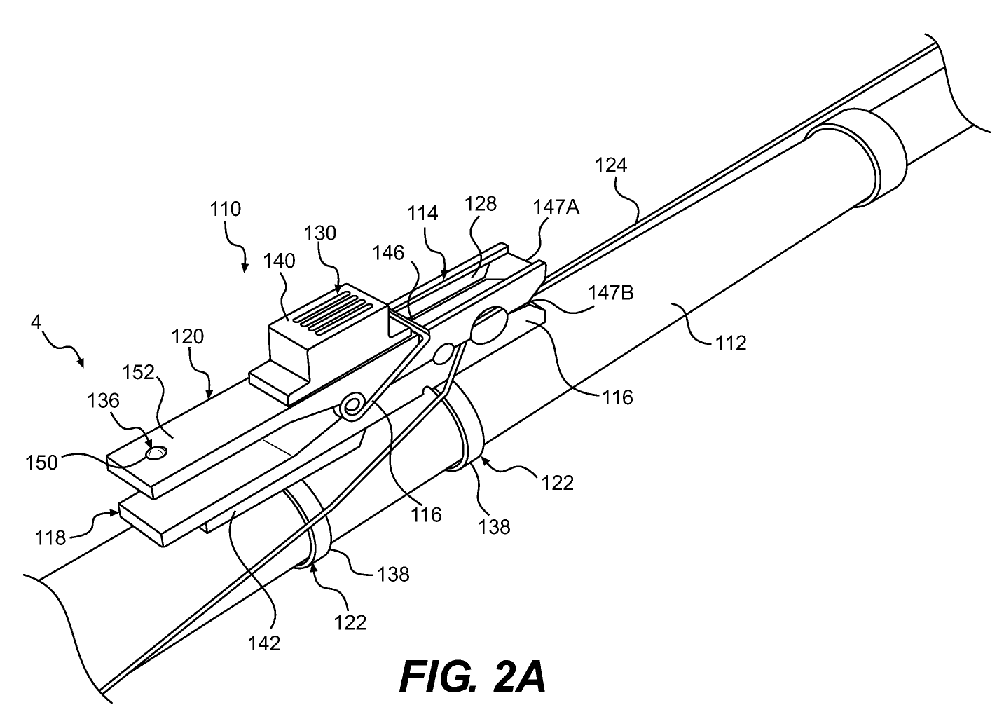

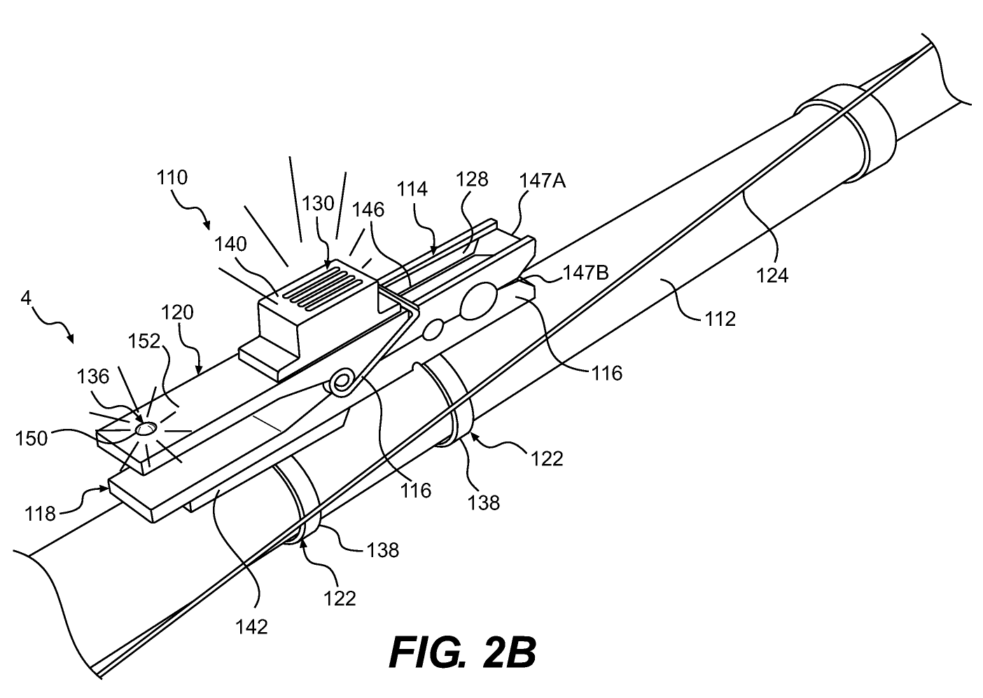

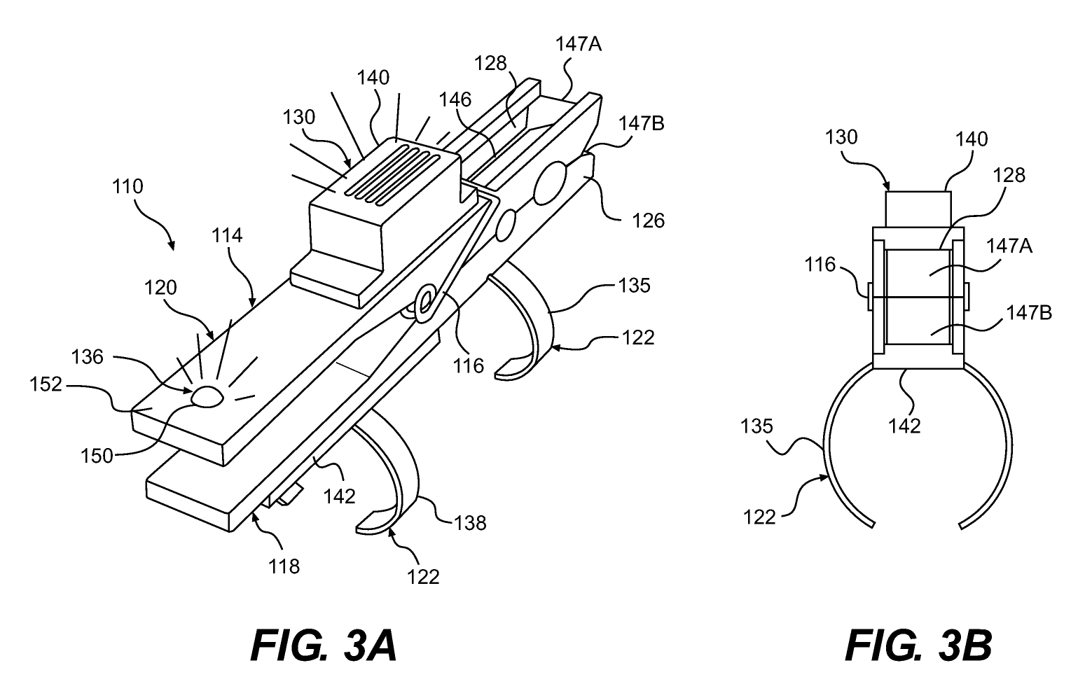

Referring now to the figures, in which like numerals indicate like parts, and particularly to FIGS. 1 through 5, the present invention will be discussed with reference thereto. The present invention is a portable fish bite alarm detector (and fishing line release) apparatus 110 for a fishing pole 112 which comprises a clothespin 114 having a spring 116 between two operable levers 118, 120. A mechanism 112 is for removably securing the first lever 118 of the clothespin 114 to the fishing pole 112. The fishing line 124 of the fishing pole 112 can be gripped by claw ends 126, 128 of the two levers 118, 120 of the clothespin 114. A mechanism 130 on the clothespin 114 is for audibly indicating that a fish 132 is nibbling bait on a hook 134 of the fishing line 124, when the fishing line 124 is pulled by the fish 132 and released from between the claw ends 126, 128 of the two levers 126, 128 of the clothespin 114.

The apparatus 110 further comprises a mechanism. 136 on the clothespin 114 for visually indicating that the fish 132 is nibbling the bait on the fishing line 124, when the fishing line 124 is pulled by the fish and released from between the claw ends 126, 128 of the two levers 118, 120 of the clothespin 114. Each of the claw ends 126, 128 have lower metal tongue 147A and upper metal tongue 147B. The removably securing mechanism 122 includes a pair of flexible C-shaped clips 138 in a spaced apart relationship affixed to the first lever 118 of the clothespin 114, whereby the flexible C-shaped clips 138 will easily snap onto the fishing pole 112.

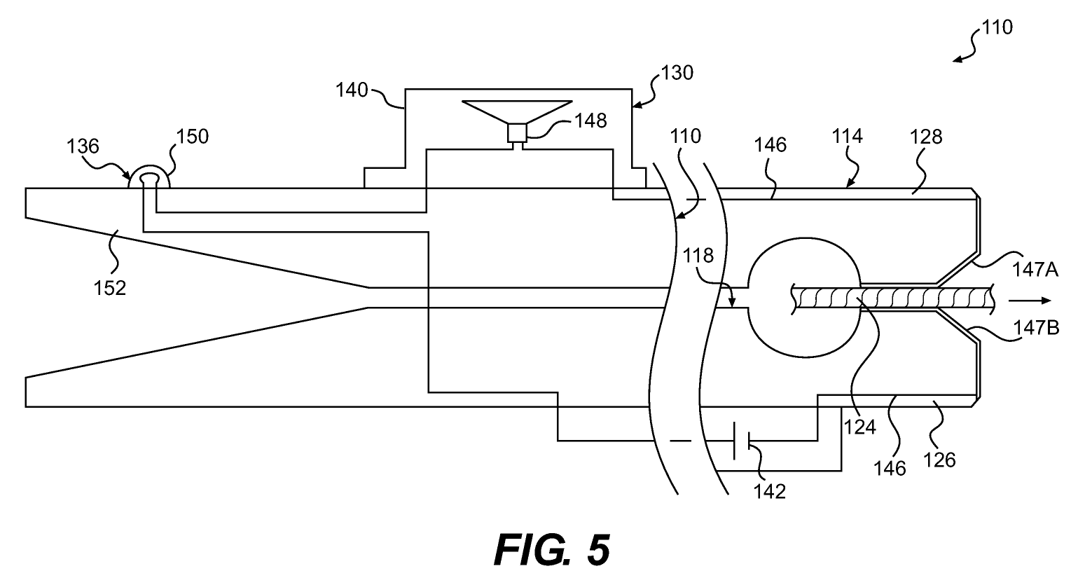

The audibly indicating mechanism 130, as best seen in FIG. 5, comprises a housing 140 attached onto the second lever 120 of the clothespin 114. A battery 142 carried in the housing 140. A normally closed contact switch 146 is mounted in the claw ends 126, 128 of the two levers 118, 120 of the clothespin 114 and is electrically connected to the battery 142. A buzzer 148 is carried in the housing 140 is electrically connected to a battery 142 in a closed loop manner.

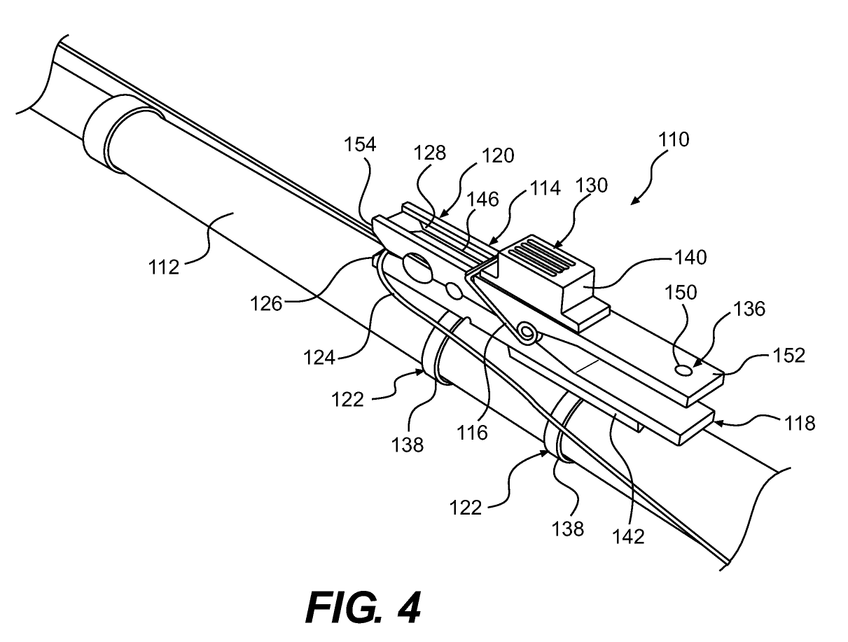

The visually indicating mechanism 136 comprises a light emitting diode (LED) 150 on a handle 152 of the second lever 120 of clothespin 114. The apparatus 110, as shown in FIG. 4 can further comprise a guide post 154 attached to and extending vertically downwardly from a side of the claw end 128 of the second lever 120 to prevent unnecessary movement and resistance of the fishing line 124 thereto.

In summary the apparatus 110 is designed to increase the chances of catching a fish 132 by automatically releasing a fishing line 124 after the fish 132 bites. This decreases the resistance of the fishing line 124 and creates a more natural feel for the fish 132, granting anglers a higher chance of success. The apparatus 110 consists of a hinged unit, such as a large clothespin 114. It has clips 138 or other suitable securing components that allows the angler to attach it to and detach it easily from a fishing pole 112. There is a small waterproof housing 140 attached to the clothespin 114 for holding a watch-sized battery 142, an indicator buzzer 148, necessary wiring. There are upper and lower metal tongues 147A-147B in claw ends 126, 128 of the two levers 118, 120 of the clothespin 114 for clamping the fishing line 124. There is also a light emitting diode (LED) 150 on a handle 152 that will light to indicate the fish 132 is on the fishing line 124. This feature would also be beneficial to determine which fishing pole 112 has a hit from a fish 132 when the angler is night fishing with multiple fishing poles 112. When the fish 132 pulled the line 124 out of the claw ends, both upper and lower metal tongues 147A-147B are then in contact forming an electrical closed-loop. So, the LED 150 is lighted, and the buzzer 148 is alarmed.

An optional guide post 154 can be placed on the clothespin 114 to prevent unnecessary movement or resistance of the fishing line 124. The apparatus 110 measures approximately 3″×½″×½″. Materials, colors and other specifications may vary upon manufacturing.

It will be understood that each of the elements described above, or two or more together, may also find a useful application in other types of constructions differing from the types described above.

While the invention has been illustrated and described as embodiments of a fish bite alarm detector, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A fish bite alarm and fishing line release apparatus for a fishing pole which comprises:
a) a clothespin having a spring between two operable levers;
b) means for removably securing the first lever of the clothespin to the fishing pole, whereby the fishing line of the fishing pole can be gripped by claw ends of the two levers of the clothespin;
c) means on the clothespin for audibly indicating that a fish is nibbling bait on a hook of the fishing line, when the fishing line is pulled by the fish and released from between the claw ends of the two levers of the clothespin; and
d) a battery has wirings connected to both claw ends and to the means for audibly indicating in an electrical closed loop.

2. The apparatus as recited in claim 1, further comprising means on the clothespin for visually indicating that a fish is nibbling the bait on the fishing line, when the fishing line is pulled by the fish and released from between the claw ends of the two levers of the clothespin.

3. The apparatus as recited in claim 1, wherein the removably securing means comprises a pair of flexible C-shaped clips in a spaced apart relationship affixed to the first lever of the clothespin, whereby the flexible C-shaped clips can be easily snapped onto the fishing pole.

4. The apparatus as recited in claim 1, wherein the audibly indicating means comprises:
a) a housing attached onto the second lever of the clothespin;
b) a normally closed contact switch mounted in the claw ends of the two levers of the clothespin and electrically connected to the battery and a visually indicating means; and
c) a buzzer carried in the housing and electrically connected to the battery and claw ends.

5. The apparatus as recited in claim 4, wherein the visually indicating means comprises a light emitting diode (LED) on a handle of the second lever of the clothespin and electrically connected between the battery, the claw ends with upper and lower metal tongues and the normally closed contact switch.

6. The apparatus as recited in claim 1, further comprising a guide post attached to and extending vertically downwardly from aside of the claw end of the second lever to prevent unnecessary movement and resistance of the fishing line thereto.
